(19) United States
(12) Patent Application Publication
(10) Pub. No.: US 2011/0320199 A1
(43) Pub. Date: Dec. 29, 2011

(54) METHOD AND APPARATUS FOR FUSING VOICED PHONEME UNITS IN TEXT-TO-SPEECH

(75) Inventors: Jian Luan, Beijing (CN); Jian Li, Beijing (CN)

(73) Assignee: Kabushiki Kaisha Toshiba

(21) Appl. No.: 13/183,667

(22) Filed: Jul. 15, 2011

Related U.S. Application Data
(63) Continuation of application No. PCT/IB2010/052931, filed on Jun. 28, 2010.

(51) Int. Cl. G10L 15/26

(52) U.S. Cl. 704/235; 704/E15.043

(57) ABSTRACT

According to one embodiment, an apparatus for fusing voiced phoneme units in Text-To-Speech, includes a reference unit selection module configured to select a reference unit from the plurality of units based on pitch cycle information of the each unit and the number of pitch cycles of the target segment. The apparatus includes a template creation module configured to create a template based on the reference unit selected by the reference unit selection module and the number of pitch cycles of the target segment, wherein the number of pitch cycles of the template is same with that of pitch cycles of the target segment. The apparatus includes a pitch cycle alignment module configured to align pitch cycles of each unit of the plurality of units except the reference unit with pitch cycles of the template by using a dynamic programming algorithm.

### CROSS REFERENCE TO RELATED APPLICATIONS

This is a Continuation Application of PCT Application No. PCT/IB2010/052931, filed Jun. 28, 2010, which was published under PCT Article 21(2) in English, the entire contents of which are incorporated herein by reference.

### FIELD

Embodiments described herein relate generally to information processing technology, particularly to text-to-speech (TTS) technology, and more particularly to technology for fusing voiced phoneme units in a unit-concatenation TTS system.

### BACKGROUND

In most current unit-concatenation TTS systems, an optimal unit is selected for each target segment and then the selected units are concatenated to form the synthesis speech. For higher stable and natural speech quality, Toshiba has proposed “plural units selection and fusion” method (see non-patent reference 1), i.e. plural units are selected for each target segment and then fused into a single one for the final concatenation. Herein, the unit fusion module for voiced units generally contains two steps:

pitch cycle mapping, in which each unit is divided into a number of pitch cycles according to the pitch mark and then the pitch cycles of plural units are aligned;

fusion of pitch cycles, in which the corresponding pitch cycles are fused respectively and finally the fused pitch cycles are concatenated to form the fused unit.

Non-patent reference 1: M. Tamura, T. Mizutani and T. Kagoshima, “Scalable concatenative speech synthesis based on the plural unit selection and fusion method”, Proc. of ICASSP2005, Philadelphia, U.S., Mar. 18-23, 2005, pp. 361-364, all of which are incorporated herein by reference.

Regarding to the pitch cycle mapping, a general method is to map pitch cycles of each selected unit to those of the target one linearly on the time axis respectively. Thus for each target pitch cycle, a corresponding pitch cycle of each selected unit can be determined. These corresponding pitch cycles from different units are aligned together not for their similarity but just for related location in the unit. If the variation of them is too great, the fusion result is generally very bad. Especially in the case of diphthongs or triphthongs (e.g. /ian/, /ueng/), they usually last long duration and the distribution of sub-phones are various by example. Thus, the conventional linear mapping easily causes the mismatch of sub-phones for a pitch cycle of a target segment.

Regarding to the fusion of each pitch cycle, speech signals are firstly divided into four sub-bands. For each sub-band, the waveforms are shifted for maximal correlation to remove the phase difference before the averaging is conducted. Finally, all the sub-bands are added up to generate the fused pitch cycle. This algorithm has low computation burden but is not accurate enough.

Regarding to the power contour of pitch cycles in the fused unit, the output power contour will be the average of all the selected units since each one of the fused pitch cycles is adjusted to have the average power of input pitch cycles, and therefore the power contour of the fused unit is the average of the power contours of the plural input units. Therefore, the final power contour is bad and the fused unit may sound unnatural only if a power contour of one unit is bad (due to noise or hoarseness).

### BRIEF DESCRIPTION OF THE DRAWINGS

FIG. 1 is a flowchart showing a method for synthesizing a speech according to an embodiment.

FIG. 2 is a flowchart showing a method for fusing voiced phoneme units according to the embodiment.

FIG. 3 is a flowchart showing a method for mapping pitch cycle according to the embodiment.

FIG. 4 shows an example of aligning pitch cycles by using a dynamic programming algorithm according to the embodiment.

FIG. 5 shows an example of a mapping table according to the embodiment.

FIGS. 6A and 6B show two examples of legal areas for the dynamic programming algorithm according to the embodiment.

FIG. 7 is a flowchart showing a method for fusing pitch cycles according to the embodiment.

FIG. 8 is a block diagram showing an apparatus for synthesizing a speech according to another embodiment.

FIG. 9 is a block diagram showing an apparatus for fusing voiced phoneme units according to the embodiment.

FIG. 10 is a block diagram showing a mapping module according to the embodiment.

FIG. 11 is a block diagram showing a pitch cycle fusion module according to the embodiment.

### DETAILED DESCRIPTION

In general, according to one embodiment, an apparatus for fusing voiced phoneme units in Text-To-Speech, includes a unit input module configured to input a plurality of units for a voiced phoneme of a target segment. The apparatus includes a unit division module configured to divide each unit of said plurality of units to obtain pitch cycles of said each unit. The apparatus includes a reference unit selection module configured to select a reference unit from said plurality of units based on pitch cycle information of said each unit and the number of pitch cycles of said target segment. The apparatus includes a template creation module configured to create a template based on said reference unit selected by said reference unit selection module and the number of pitch cycles of said target segment, wherein the number of pitch cycles of said template is same with that of pitch cycles of said target segment. The apparatus includes a pitch cycle alignment module configured to align pitch cycles of each unit of said plurality of units except said reference unit with pitch cycles of said template by using a dynamic programming algorithm. The apparatus includes a pitch cycle fusion module configured to fuse said pitch cycles aligned by said pitch cycle alignment module. The apparatus includes a pitch cycle concatenation module configured to concatenate said pitch cycles fused by said pitch cycle fusion module into a fused unit of said target segment.

Next, a detailed description of the preferred embodiments will be given in conjunction with the drawings.

### Method for Synthesizing a Speech

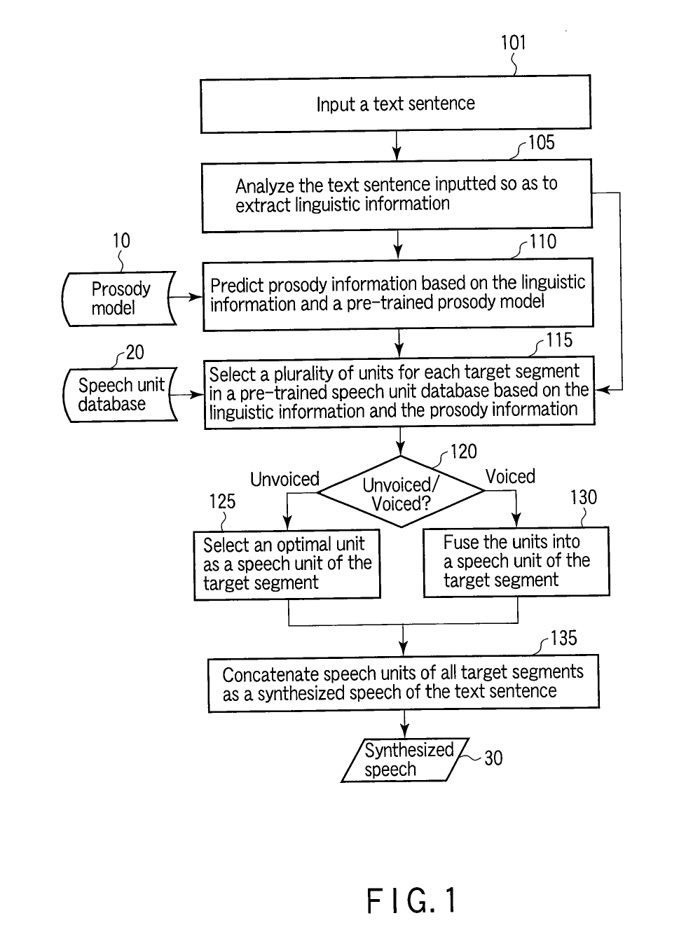

FIG. 1 is a flowchart showing a method for synthesizing a speech according to an embodiment. Next, the embodiment will be described in conjunction with the drawing.

As shown in FIG. 1, first in step 101, a text sentence is inputted. In the embodiment, the text sentence inputted can be any text sentence known by those skilled in the art and can be a text sentence of any language such as Chinese, English, Japanese etc., and the embodiment has no limitation on this.

Next, in step 105, the text sentence inputted is analyzed by using a text analysis method to extract linguistic information from the text sentence inputted. In the embodiment, the linguistic information includes context information, and specifically includes length of the text sentence, and character, pinyin, phoneme type, tone type, part of speech, relative position, boundary type with a previous/next character (word) and distance from/to a previous/next pause etc. of each character (word) in the text sentence. Further, in the embodiment, the text analysis method for extracting the linguistic information from the text sentence inputted can be any method known by those skilled in the art, and the embodiment has no limitation on this.

Next, in step 110, prosody information is predicted based on the linguistic information and a pre-trained prosody model 10. In the embodiment, the prosody model 10 is made in advance based on a speech corpus. The prosody information includes loudness of a sound, length of a sound, intensity of a sound, duration of a sound, and pause etc. Moreover, in the embodiment, the method for training the prosody model and the method for predicting the prosody information can be any method known by those skilled in the art, and the embodiment has no limitation on this.

After step 110, the text sentence is divided into a plurality of target segments.

Next, in step 115, a plurality of units for each target segment is selected in a pre-trained speech unit database 20 based on the linguistic information and the prosody information. In the embodiment, the speech unit database 20 is made in advance based on a speech corpus. Each of the selected units is a candidate speech of the target segment. Moreover, in the embodiment, the method for training the speech unit database and the method for selecting the plurality of units can be any method known by those skilled in the art, and the embodiment has no limitation on this.

Next, in step 120, an unvoiced/voiced decision is made for each target segment, i.e. it is decided whether the target segment is an unvoiced phoneme or a voiced phoneme. In the embodiment, any method known by those skilled in the art the method can be used for performing the unvoiced/voiced decision, and the embodiment has no limitation on this.

If it is decided in step 120 the target segment is an unvoiced phoneme, the method proceeds to step 125, in which an optimal unit is selected from the plurality of units as a speech unit of the target segment. Moreover, optionally, power of the selected optimal unit is adjusted so as to adjust its magnitude. In the embodiment, the method for selecting the optimal unit and the method for adjusting the power can be any method known by those skilled in the art, and the embodiment has no limitation on this.

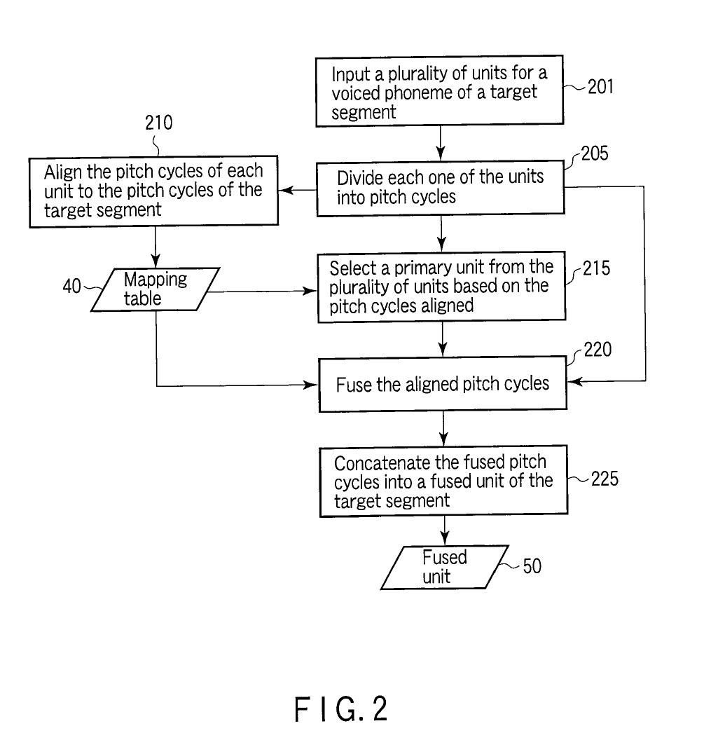

If it is decided in step 120 the target segment is a voiced phoneme, the method proceeds to step 130, in which said plurality of units selected are fused into a speech unit of the target segment. The method for fusing voiced phoneme units will be described below in detail with reference to FIG. 2 and omitted here.

Finally, in step 135, speech units of all target segments are concatenated into a synthesized speech 30 of the text sentence. In the embodiment, the method for concatenating the speech units can be any method known by those skilled in the art, and the embodiment has no limitation on this.

### Method for Fusing Voiced Phoneme Units

FIG. 2 is a flowchart showing a method for fusing voiced phoneme units according to the embodiment. The description of the method for fusing voiced phoneme units of this embodiment will be given below in conjunction with FIG. 2.

As shown in FIG. 2, first in step 201, a plurality of units for a voiced phoneme of a target segment are inputted.

Next, in step 205, each unit of the plurality of units is divided with respect to a pitch cycle to obtain pitch cycles of said each unit. In the embodiment, the method for dividing the pitch cycles can be any method known by those skilled in the art, and the embodiment has no limitation on this. For example, a T-D PSOLA (Time-Domain Pitch-Synchronous Overlap-Add) algorithm (see non-patent reference 2: Hamon, C., Moulines, E. and Charpentier, F., “A diphone synthesis system based on time-domain prosodic modifications of speech”, ICASSP'89, May 22-25, Glasgow, Scotland, pp. 238-241, 1989, all of which are incorporated herein by reference) can be used to divide each unit with respect to a pitch cycle.

Next, in step 210, the pitch cycles of each unit are aligned with the pitch cycles of the target segment and a mapping table 40 is obtained.

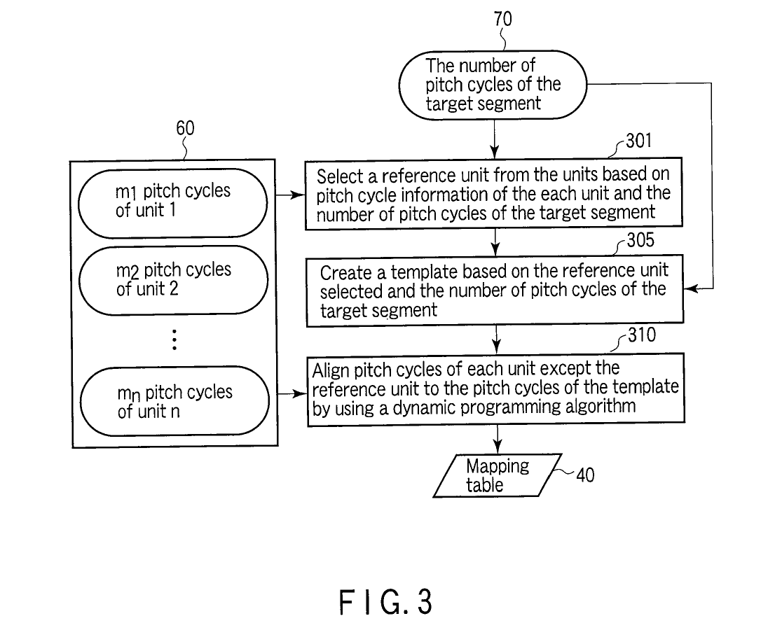

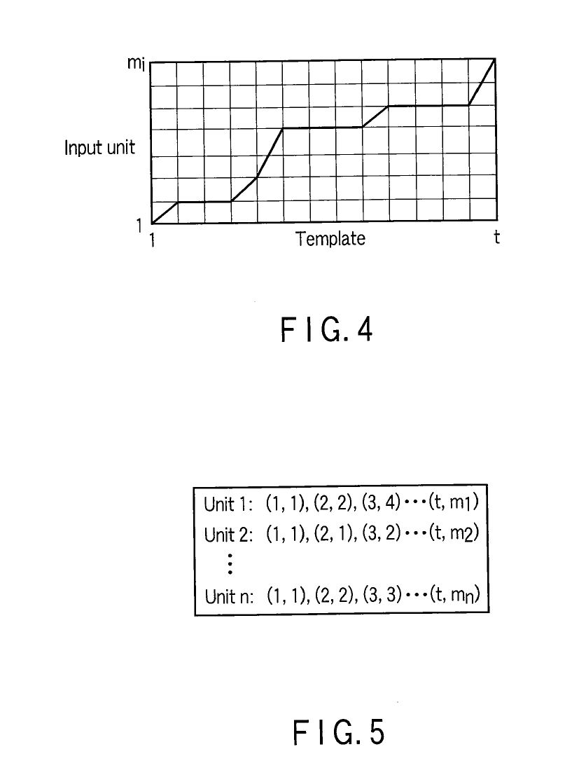

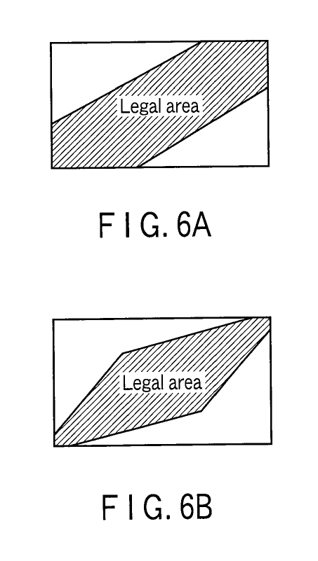

The mapping method will be described in detail below with reference to FIGS. 3-6. FIG. 3 is a flowchart showing a method for mapping pitch cycle according to the embodiment. FIG. 4 shows an example of aligning pitch cycles by using a dynamic programming algorithm according to the embodiment. FIG. 5 shows an example of a mapping table 40 according to the embodiment. FIG. 6 shows two examples of legal areas for the dynamic programming algorithm according to the embodiment.

As shown in FIG. 3, first in step 301, a reference unit is selected from the plurality of units based on pitch cycle information 60 of each unit and the number 70 of pitch cycles of the target segment. Here, it is supposed that the input unit 1 consists of m1 pitch cycles, input unit 2 consists of m2 pitch cycles and so on, while the target segment consists of t pitch cycles. In the embodiment, optionally, the one whose number of pitch cycles is closest to t in the plurality of units can be used as the reference unit.

Next, in step 305, a template is created based on the reference unit selected and the number of pitch cycles of the target segment. That is to say, a template having t pitch cycles is created from the reference unit. It can be done by copying or deleting some pitch cycles linearly in conventional way.

Finally, in step 310, pitch cycles of each unit of the plurality of units except the reference unit are aligned with the pitch cycles of the template by using a dynamic programming algorithm. The dynamic programming algorithm will be described below in detail with reference to FIG. 4.

As shown in FIG. 4, the similarity of each pitch cycle pair (presented as a crossing point) is calculated and the path having greatest cumulative similarity score is chosen as the alignment result. All the pitch cycle pairs in the optimal path are recorded in the mapping table 40. An example of the mapping table 40 is shown in FIG. 5. There are two numbers in each bracket for a pitch cycle pair. The former one is the pitch cycle index of the template while the latter is that of the input unit. The first row records the alignment result for the input unit 1 and others rows are alike. The similarity measurement used in searching the optimal path may be the correlation of waveforms, magnitude spectra or the like. For the sake of ease, it can be forced to align one and only one pitch cycle of each input unit with a pitch cycle of the template. Moreover, the legal pitch cycle pairs may be limited in a reasonable area to reduce the computation burden. Two examples of legal area are shown in FIG. 6. A boundary relaxation may also be applied to remove the influence of inconsistent unit labeling. The boundary relaxation means that the pitch cycle aligned with the first/last pitch cycle of the template is not always the first/last one of input unit. In other words, the optimal path may begin with (1, 2), (1, 3) and end with (t, m1−1), (t, m1−2).

In the embodiment, any dynamic programming algorithm known by those skilled in the art can be used to perform the alignment, and the embodiment has no limitation on this.

Moreover, in the embodiment, in step 301, the method including the following steps can be used for selecting a better reference unit:

selecting a unit from the plurality of units as a candidate unit and creating a template based on the candidate unit and the number of pitch cycles of the target segment by using the method of step 305;

aligning pitch cycles of each unit of the plurality of units except the candidate unit with pitch cycles of the template by using the dynamic programming algorithm of step 310 to obtain a mapping table 40;

calculating a similarity between each aligned pitch cycle pair of the template and the each unit;

calculating the sum of similarities of all aligned pitch cycle pairs of the template and the each unit, wherein the sum is used as a similarity between the template and the each unit;

calculating the sum of similarities of the candidate unit with other units of the plurality of units except the candidate unit, wherein the sum of similarities is used as a total similarity between the candidate unit and the other units; and

using the plurality of units one by one as the candidate unit and calculating a total similarity between the candidate unit and other units, wherein a unit having a maximum total similarity with other units is used as the reference unit.

Return to FIG. 2, next, in step 215, a primary unit is selected from the plurality of selected units based on the pitch cycles aligned, i.e. the mapping table 40. In the embodiment, the above-mentioned reference unit can be used as the primary unit or the primary unit can be selected by using a method including the following steps of:

extracting pitch cycles aligned with each pitch cycle of the template created in step 305 from each unit of the plurality of units except the reference unit with respect to the each pitch cycle, wherein pitch cycles extracted by the pitch cycle collection module and the each pitch cycle are collected as a group;

calculating a similarity between each two pitch cycles in each group;

calculating the sum of similarities corresponding to the each two pitch cycles in all groups, wherein the sum is used as a similarity between two units corresponding to the each two pitch cycles in the plurality of units; and

calculating the sum of similarities of each unit of the plurality of units with other units, wherein a unit having a maximum sum of similarities with other units in the plurality of units is used as the primary unit.

Next, in step 220, the aligned pitch cycles are fused. In the embodiment, any method known by those skilled in the art can be used for fusing the aligned pitch cycles, and in this case, step 215 of selecting a primary unit is an optional step and it can be determined whether step 215 is performed or not in according to the actual demand. Moreover, preferably, a method for fusing pitch cycles described below is used to perform step 220, and in this case, step 215 is needed to select the primary unit.

Finally, in step 225, the fused pitch cycles are concatenated into a fused unit 50 of the target segment, i.e. a speech unit of the target segment. In the embodiment, the method for concatenating the fused pitch cycles can be any method known by those skilled in the art, and the present has no limitation on this. For example, the T-D PSOLA algorithm described in the above non-patent reference 2 can be used to concatenate the fused pitch cycles.

In the method for fusing voiced phoneme units of the embodiment, the dynamic programming algorithm is introduced for the pitch cycle mapping, i.e. pitch cycle aligning. Since the similarity measurement of pitch cycle signals may be the correlation of waveforms, magnitude spectra or the like, the path having greatest cumulative similarity score is chosen as the alignment result and recorded in a mapping table. Since the pitch cycle alignment is performed dynamically, the pitch cycles to be fused together have better consistency.

### Method for Fusing Pitch Cycles

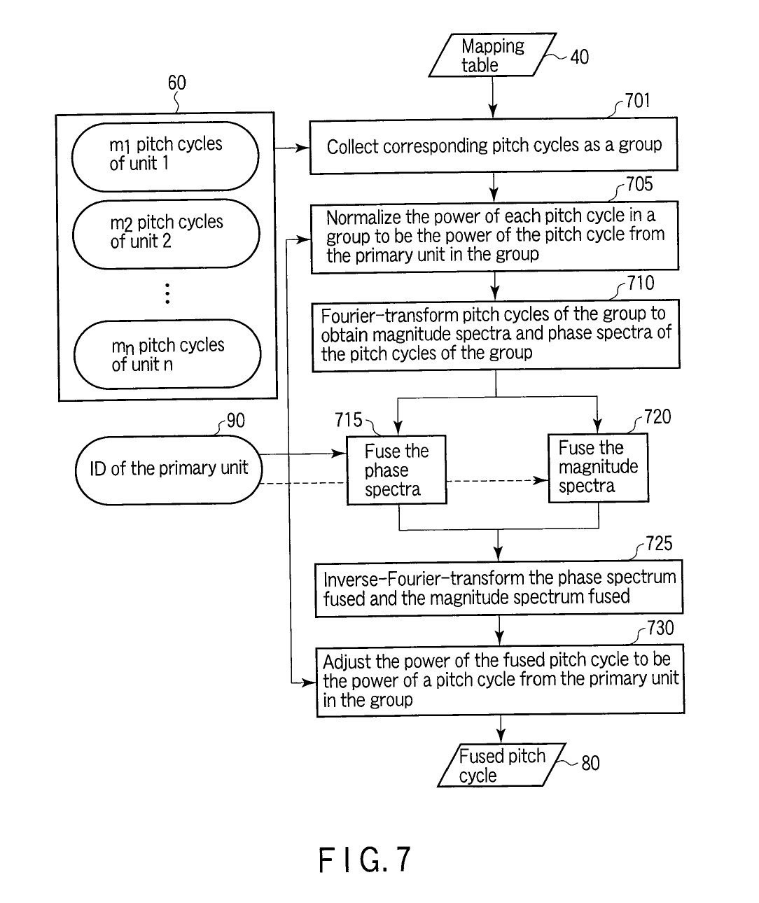

FIG. 7 is a flowchart showing a method for fusing pitch cycles according to the embodiment. The description of the method for fusing pitch cycles of this embodiment will be given below in conjunction with FIG. 7.

As shown in FIG. 7, first in step 701, pitch cycles aligned with each pitch cycle of the template are extracted from each unit of the plurality of units except the reference unit with respect to the each pitch cycle, wherein the extracted pitch cycles and the each pitch cycle are collected as a group. That is to say, the pitch cycles corresponding to the same pitch cycle of the template are extracted from the divided pitch cycles 60 and grouped together. In the embodiment, the method for grouping the pitch cycles can be any method known by those skilled in the art, and the present has no limitation on this.

Next, in step 705, the power of each pitch cycle in a group is normalized to be a same value, i.e. the power of a pitch cycle from the primary unit in the group.

Next, in step 710, waveforms of pitch cycle signals of the group are Fourier-transformed to obtain magnitude spectra and phase spectra of the pitch cycles of the group. In the embodiment, FFT can be used for the Fourier-transform or any method known by those skilled in the art can be used for the Fourier-transform, and the present has no limitation on this.

Next, in step 715, the phase spectra of the pitch cycles of the group are fused. In the embodiment, preferably, it is suggested to directly choose the phase spectrum from the primary unit as the fused phase spectrum.

Next, in step 720, the magnitude spectra of the pitch cycles of the group are fused. In the embodiment, preferably, the magnitude spectra of the pitch cycles of the group are log-averaged as the fused magnitude spectrum. More preferably, the formants alignment may be implemented based on the primary one before the magnitude spectra of the pitch cycles of the group are log-averaged.

Next, in step 725, the fused phase spectrum and the fused magnitude spectrum are inverse-Fourier-transformed (e.g. FFT) to reconstruct a waveform and obtain the fused pitch cycle.

Finally, in step 730, the power of the fused pitch cycle is adjusted to be the power of a pitch cycle from the primary unit in the group to obtain the fused pitch cycle 80.

In the embodiment, step 705 of normalizing power and step 730 of adjusting power are all optional steps, which can be omitted in the embodiment.

In the method for fusing voiced phoneme units of the embodiment, the fusion of pitch cycles is implemented on the FFT (Fast Fourier Transform) spectrum. Magnitude spectra are formant-aligned and then averaged on the log scale while the phase spectrum of the primary unit is directly used. The pitch cycle fusion based on FFT spectrum processes the magnitude and phase spectra respectively. It accords with the physical essence of speech signal better. The primary unit supplies the phase spectrum of the fused unit. Thus, if only a good primary unit is selected, the probably bad phase spectrum of other units will not affect the final fused unit.

Moreover, in the method for fusing voiced phoneme units of the embodiment, for the fused unit, the power of a pitch cycle of the primary unit is used as the power of each fused pitch cycle, so the power contour of the fused unit is the power contour of the primary unit rather than the average of all the selected units. Thus, if only the power contour of the primary unit is good, the power contour of the fused unit is good. That is to say, if only a good primary unit is selected, the probably bad power contour of other units will not affect the final fused unit.

Further, in the method for synthesizing a speech of the embodiment, since the plurality of units are fused into a speech unit of the target segment by using the above-mentioned method for fusing voiced phoneme units if the target segment is a voiced phoneme, the performance of the synthesized speech can be evidently enhanced.

### Apparatus for Synthesizing a Speech

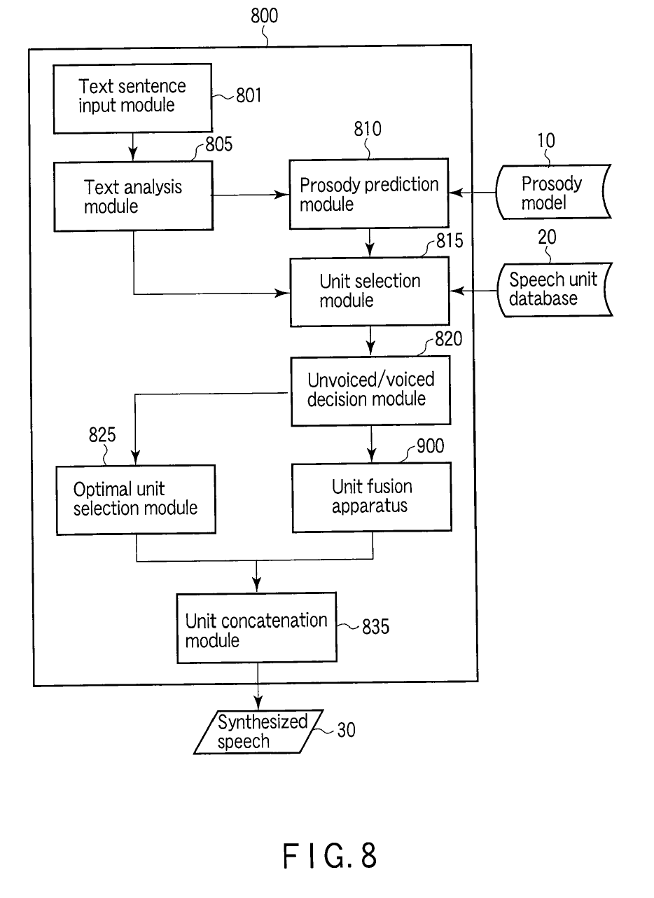

Based on the same concept of the embodiment, FIG. 8 is a block diagram showing an apparatus for synthesizing a speech according to another embodiment. The description of this embodiment will be given below in conjunction with FIG. 8, with a proper omission of the same content as those in the above-mentioned embodiments.

As shown in FIG. 8, an apparatus 800 for synthesizing a speech according to the embodiment comprises: a text sentence input module 801 configured to input a text sentence; a text analysis module 805 configured to analyze the text sentence inputted so as to extract linguistic information; a prosody prediction module 810 configured to predict prosody information based on the linguistic information and a pre-trained prosody model 10; a unit selection module 815 configured to select a plurality of units for each target segment in a pre-trained speech unit database 20 based on the linguistic information and the prosody information; an unvoiced/voiced decision module 820 to decide if the target segment is an unvoiced phoneme or a voiced phoneme; an optimal unit selection module 825 configured to select an optimal unit from the plurality of units as a speech unit of the target segment if the target segment is an unvoiced phoneme; apparatus 900 for fusing voiced phoneme units configured to fuse the plurality of units as a speech unit of the target segment by using the above-mentioned method for fusing voiced phoneme units if the target segment is a voiced phoneme; and a unit concatenation module 835 configured to concatenate speech units of all target segments as a synthesized speech 30 of the text sentence.

In the embodiment, the text sentence inputted by the input module 801 can be any text sentence known by those skilled in the art and can be a text sentence of any language such as Chinese, English, Japanese etc., and the embodiment has no limitation on this.

The text sentence inputted is analyzed by the text analysis module 805 to extract linguistic information from the text sentence inputted. In the embodiment, the linguistic information includes context information, and specifically includes length of the text sentence, and character, pinyin, phoneme type, tone type, part of speech, relative position, boundary type with a previous/next character (word) and distance from/to a previous/next pause etc. of each character (word) in the text sentence. Further, in the embodiment, the text analysis method for extracting the linguistic information from the text sentence inputted can be any method known by those skilled in the art, and the embodiment has no limitation on this.

Prosody information is predicted based on the linguistic information and a pre-trained prosody model 10 by using the prosody prediction module 810. In the embodiment, the prosody model 10 is made in advance based on a speech corpus. The prosody information includes loudness of a sound, length of a sound, intensity of a sound, duration of a sound, and pause etc. Moreover, in the embodiment, the method for training the prosody model can be any method known by those skilled in the art, and the prosody prediction module 810 can be any module known by those skilled in the art, and the embodiment has no limitation on this.

In the text analysis module 805 and the prosody prediction module 810, the text sentence is divided into a plurality of target segments.

A plurality of units for each target segment is selected by using the unit selection module 815 in a pre-trained speech unit database 20 based on the linguistic information and the prosody information. In the embodiment, the speech unit database 20 is made in advance based on a speech corpus. Each of the selected units is a candidate speech of the target segment. Moreover, in the embodiment, the method for training the speech unit database can be any method known by those skilled in the art and the unit selection module 815 can be any module known by those skilled in the art, and the embodiment has no limitation on this.

An unvoiced/voiced decision is made by the unvoiced/voiced decision module 820 for each target segment, i.e. it is decided whether the target segment is an unvoiced phoneme or a voiced phoneme. In the embodiment, the unvoiced/voiced decision module 820 can be any module for performing the unvoiced/voiced decision known by those skilled in the art, and the embodiment has no limitation on this.

If it is decided by the unvoiced/voiced decision module 820 the target segment is an unvoiced phoneme, an optimal unit is selected by the optimal unit selection module 825 from the plurality of units as a speech unit of the target segment. Moreover, optionally, power of the selected optimal unit is adjusted so as to adjust its magnitude. In the embodiment, the optimal unit selection module 825 can be any module known by those skilled in the art and the method for adjusting the power can be any method known by those skilled in the art, and the embodiment has no limitation on this.

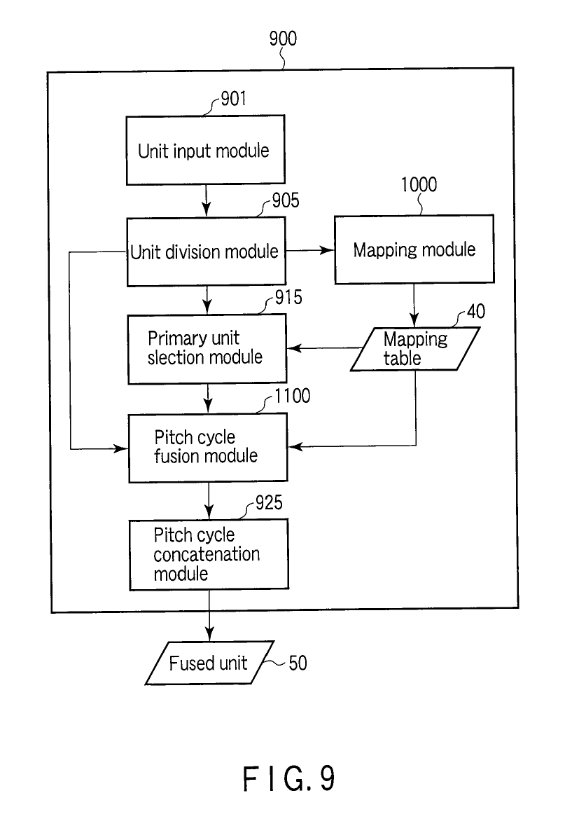

If it is decided by the unvoiced/voiced decision module 820 the target segment is a voiced phoneme, the plurality of units selected are fused by the apparatus 900 for fusing voiced phoneme units as a speech unit of the target segment. The apparatus 900 for fusing voiced phoneme units will be described below in detail with reference to FIG. 9 and omitted here.

Speech units of all target segments are concatenated by the unit concatenation module 835 as a synthesized speech 30 of the text sentence. In the embodiment, the unit concatenation module 835 can be any module known by those skilled in the art, and the embodiment has no limitation on this.

### Apparatus for Fusing Voiced Phoneme Units

FIG. 9 is a block diagram showing an apparatus for fusing voiced phoneme units according to the embodiment. The description of the method for fusing voiced phoneme units of this embodiment will be given below in conjunction with FIG. 9.

As shown in FIG. 9, the apparatus 900 for fusing voiced phoneme units according to the embodiment includes: a unit input module 901, a unit division module 905, a mapping module 1000, a primary unit selection module 915, a pitch cycle fusion module 1100 and a pitch cycle concatenation module 925. These modules will be described below respectively.

A plurality of units for a voiced phoneme of a target segment are inputted by the unit input module 901.

Each unit of the plurality of units is divided by the unit division module 905 with respect to a pitch cycle to obtain pitch cycles of said each unit. In the embodiment, the unit division module 905 can be any module for dividing the pitch cycles known by those skilled in the art, and the embodiment has no limitation on this. For example, a T-D PSOLA algorithm described in the above non-patent reference 2 can be used by the unit division module 905 to divide each unit with respect to a pitch cycle.

The pitch cycles of each unit are aligned with the pitch cycles of the target segment by the mapping module 1000 to obtain a mapping table 40.

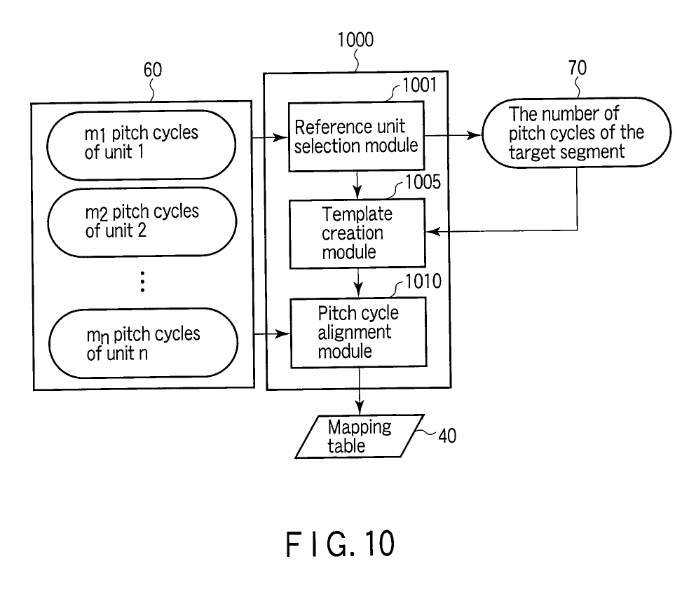

The mapping module 1000 will be described in detail below with reference to FIG. 10. FIG. 10 is a block diagram showing a mapping module according to the embodiment.

As shown in FIG. 10, the mapping module 1000 according to the embodiment includes: a reference unit selection module 1001, a template creation module 1005 and a pitch cycle alignment module 1010. These modules will be described below respectively.

A reference unit is selected by the reference unit selection module 1001 from the plurality of units based on pitch cycle information 60 of each unit and the number 70 of pitch cycles of the target segment. Here, it is supposed that the input unit 1 consists of m1 pitch cycles, the input unit 2 consists of m2 pitch cycles and so on, while the target segment consists of t pitch cycles. In the embodiment, optionally, the one whose number of pitch cycles is closest to t in the plurality of units can be used as the reference unit.

A template is created by the template creation module 1005 based on the reference unit selected by the reference unit selection module 1001 and the number of pitch cycles of the target segment. That is to say, a template having t pitch cycles is created from the reference unit. It can be done by copying or deleting some pitch cycles linearly in conventional way.

Pitch cycles of each unit of the plurality of units except the reference unit are aligned by the pitch cycle alignment module 1010 with pitch cycles of the template by using a dynamic programming algorithm. The dynamic programming algorithm performed by the pitch cycle alignment module 1010 will be described below in detail with reference to FIG. 4.

As shown in FIG. 4, the similarity of each pitch cycle pair (presented as a crossing point) is calculated and the path having greatest cumulative similarity score is chosen as the alignment result.

All the pitch cycle pairs in the optimal path are recorded in the mapping table 40. An example of the mapping table 40 is shown in FIG. 5. There are two numbers in each bracket for a pitch cycle pair. The former one is the pitch cycle index of the template while the latter is that of the input unit. The first row records the alignment result for the input unit 1 and others rows are alike. The similarity measurement used in searching the optimal path may be the correlation of waveforms, magnitude spectra or the like. For the sake of ease, it can be forced to align one and only one pitch cycle of each input unit with a pitch cycle of the template. Moreover, the legal pitch cycle pairs may be limited in a reasonable area to reduce the computation burden. Two examples of legal area are shown in FIG. 6. A boundary relaxation may also be applied to remove the influence of inconsistent unit labeling. The boundary relaxation means that the pitch cycle aligned with the first/last pitch cycle of the template is not always the first/last one of input unit. In other words, the optimal path may begin with (1, 2), (1, 3) and end with (t, m1−1), (t, m1−2).

In the embodiment, any dynamic programming algorithm known by those skilled in the art can be used to perform the alignment, and the embodiment has no limitation on this.

Moreover, in the embodiment, in order to select a better reference unit, the reference unit selection module 1001 further includes a calculating module, and the reference unit can be selected by a method including the following steps of:

selecting a unit from the plurality of units as a candidate unit and creating a template based on the candidate unit and the number of pitch cycles of the target segment by using the template creation module 1005;

aligning pitch cycles of each unit of the plurality of units except the candidate unit with pitch cycles of the template by using the pitch cycle alignment module 1010 to obtain a mapping table 40; and

using the calculating module to:

calculate a similarity between each aligned pitch cycle pair of the template and the each unit;

calculate the sum of similarities of all aligned pitch cycle pairs of the template and the each unit, wherein the sum is used as a similarity between the template and the each unit;

calculate the sum of similarities of the candidate unit with other units of the plurality of units except the candidate unit, wherein the sum of similarities is used as a total similarity between the candidate unit and the other units; and

use the plurality of units one by one as the candidate unit and calculate a total similarity between the candidate unit and other units, wherein a unit having a maximum total similarity with other units is used as the reference unit.

Return to FIG. 9, a primary unit is selected by the primary unit selection module 915 from the plurality of selected units based on the pitch cycles aligned, i.e. the mapping table 40. In the embodiment, the above-mentioned reference unit can be used as the primary unit, or a pitch cycle collection module and a calculating module are arranged in the primary unit selection module 915 and the primary unit can be selected by using a method including the following steps of:

extracting pitch cycles aligned with each pitch cycle of the template created by the template creation module 1005 from each unit of the plurality of units except the reference unit with respect to the each pitch cycle by using the pitch cycle collection module, wherein pitch cycles extracted by the pitch cycle collection module and the each pitch cycle are collected as a group; and

using the calculation module to:

calculating a similarity between each two pitch cycles in each group;

calculating the sum of similarities corresponding to the each two pitch cycles in all groups, wherein the sum is used as a similarity between two units corresponding to the each two pitch cycles in the plurality of units; and

calculating the sum of similarities of each unit of the plurality of units with other units, wherein a unit having a maximum sum of similarities with other units in the plurality of units is used as the primary unit.

The aligned pitch cycles are fused by the pitch cycle fusion module 1100. In the embodiment, the pitch cycle fusion module 1100 can be any module for fusing the aligned pitch cycles known by those skilled in the art, and in this case, the primary unit selection module 915 is an optional module and it can be determined whether the primary unit selection module 915 is arranged or not in according to the actual demand. Moreover, preferably, the pitch cycle fusion module 1100 of the embodiment described below is arranged, and in this case, the primary unit selection module 915 is needed to be arranged.

The fused pitch cycles are concatenated by the pitch cycle concatenation module 925 into a fused unit 50 of the target segment, i.e. a speech unit of the target segment. In the embodiment, the pitch cycle concatenation module 925 can be any module for concatenating the fused pitch cycles known by those skilled in the art, and the present has no limitation on this. For example, the T-D PSOLA algorithm described in the above non-patent reference 2 can be used by the pitch cycle concatenation module 925 to concatenate the fused pitch cycles.

In the apparatus 900 for fusing voiced phoneme units of the embodiment, the dynamic programming algorithm is introduced for the pitch cycle mapping, i.e. pitch cycle aligning. Since the similarity measurement of pitch cycle signals may be the correlation of waveforms, magnitude spectra or the like, the path having greatest cumulative similarity score is chosen as the alignment result and recorded in a mapping table. Since the pitch cycle alignment is performed dynamically, the pitch cycles to be fused together have better consistency.

### Apparatus for Fusing Pitch Cycles

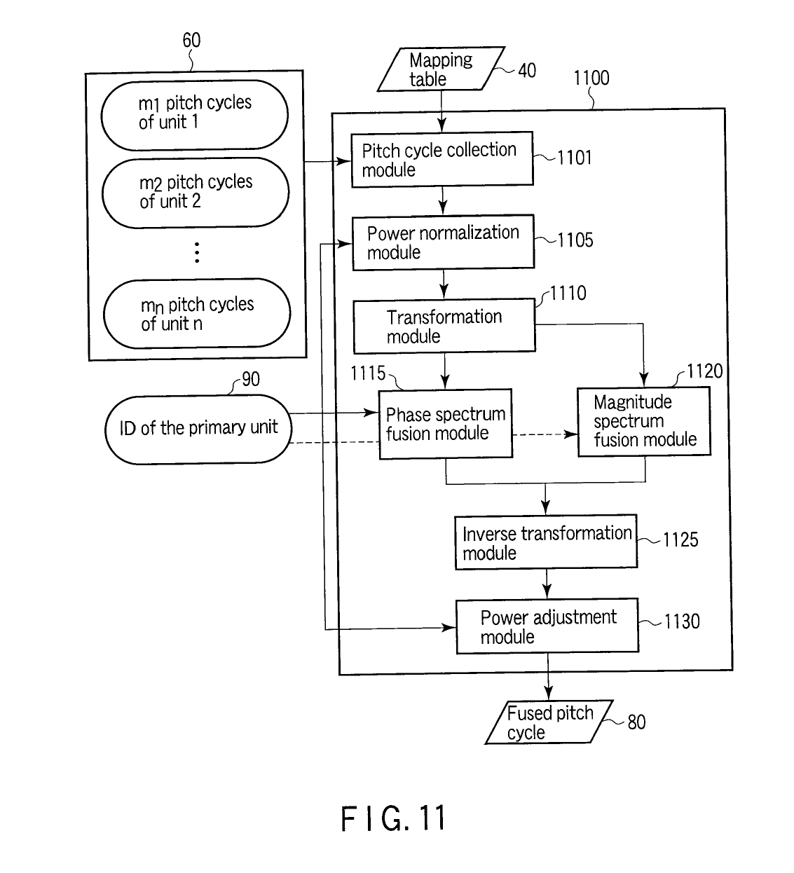

FIG. 11 is a block diagram showing a pitch cycle fusion module according to the embodiment. The description of the method for fusing pitch cycles of this embodiment will be given below in conjunction with FIG. 11.

As shown in FIG. 11, the apparatus for fusing pitch cycles 1000 according to the embodiment includes: a pitch cycle collection module 1101, a power normalization module 1105, a transformation module 1110, a phase spectrum fusion module 1115, a magnitude spectrum fusion module 1120, an inverse transformation module 1125 and a power adjustment module 1130. These modules will be described below respectively.

Pitch cycles aligned with each pitch cycle of the template are extracted by the pitch cycle collection module 1101 from each unit of the plurality of units except the reference unit with respect to the each pitch cycle, wherein the extracted pitch cycles and the each pitch cycle are collected as a group. That is to say, the pitch cycles corresponding to the same pitch cycle of the template are extracted from the divided pitch cycles 60 and grouped together. In the embodiment, the pitch cycle collection module 1101 can by any module for grouping the pitch cycles known by those skilled in the art, and the present has no limitation on this.

The power of each of pitch cycles of the group is normalized by the power normalization module 1105 to be a same value, i.e. the power of a pitch cycle from the primary unit in the group.

Waveforms of pitch cycle signals of the group are Fourier-transformed by the transformation module 1110 to obtain magnitude spectra and phase spectra of the pitch cycles of the group. In the embodiment, the transformation module 1110 can be an FFT module or any module for the Fourier-transform known by those skilled in the art, and the present has no limitation on this.

The phase spectra of the pitch cycles of the group are fused by the phase spectrum fusion module 1115. In the embodiment, preferably, it is suggested by the phase spectrum fusion module 1115 to directly choose the phase spectrum from the primary unit as the fused phase spectrum.

The magnitude spectra of the pitch cycles of the group are fused by the magnitude spectrum fusion module 1120. In the embodiment, preferably, the magnitude spectrum fusion module 1120 includes a calculating module configured to calculate a log-average of the magnitude spectra of the pitch cycles of the group as the fused magnitude spectrum. More preferably, the magnitude spectrum fusion module 1120 includes a formant alignment module configured to implement the formants alignment based on the primary one before the magnitude spectra of the pitch cycles of the group are log-averaged.

The fused phase spectrum and the fused magnitude spectrum are inverse-Fourier-transformed by the inverse transformation module 1125 to reconstruct a waveform and obtain the fused pitch cycle. The inverse transformation module 1125 is for example an IFFT module.

The power of the fused pitch cycle is adjusted by the power adjustment module 1130 to be the power of a pitch cycle from the primary unit in the group to obtain the fused pitch cycle 80.

In the embodiment, the power normalization module 1105 and the power adjustment module 1130 are all optional modules, which can be omitted in the embodiment.

In the apparatus 900 for fusing voiced phoneme units of the embodiment, the fusion of pitch cycles is implemented on the FFT (Fast Fourier Transform) spectrum. Magnitude spectra are formant-aligned and then averaged on the log scale while the phase spectrum of the primary unit is directly used. The pitch cycle fusion based on FFT spectrum processes the magnitude and phase spectra respectively. It accords with the physical essence of speech signal better. The primary unit supplies the phase spectrum of the fused unit. Thus, if only a good primary unit is selected, the probably bad phase spectrum of other units will not affect the final fused unit.

Moreover, in the apparatus 900 for fusing voiced phoneme units of the embodiment, for the fused unit, the power of a pitch cycle of the primary unit is used as the power of each fused pitch cycle, so the power contour of the fused unit is the power contour of the primary unit rather than the average of all the selected units. Thus, if only the power contour of the primary unit is good, the power contour of the fused unit is good. That is to say, if only a good primary unit is selected, the probably bad power contour of other units will not affect the final fused unit.

Further, in the apparatus 800 for synthesizing a speech of the embodiment, since the plurality of units are fused into a speech unit of the target segment by using the above-mentioned method for fusing voiced phoneme units if the target segment is a voiced phoneme, the performance of the synthesized speech can be evidently enhanced.

Though the method and apparatus for fusing voiced phoneme units in TTS and the method and apparatus for synthesizing a speech have been described in details with some exemplary embodiments, these above embodiments are not exhaustive. Those skilled in the art may make various variations and modifications within the spirit and scope of the present invention. Therefore, the present invention is not limited to these embodiments; rather, the scope of the present invention is only defined by the appended claims.

The application purposes of the present invention may not be limited to fusing plural selected units and it can be also applied to smooth the unit boundary in concatenating the units. The smoothing, in general, can be approached as a fusion of two pitch cycles on the boundary from neighboring units with fade-in-fade-out weights.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for fusing voiced phoneme units in Text-To-Speech, comprising:
a unit input module configured to input a plurality of units for a voiced phoneme of a target segment;
a unit division module configured to divide each unit of said plurality of units to obtain pitch cycles of said each unit;
a reference unit selection module configured to select a reference unit from said plurality of units based on pitch cycle information of said each unit and the number of pitch cycles of said target segment;
a template creation module configured to create a template based on said reference unit selected by said reference unit selection module and the number of pitch cycles of said target segment, wherein the number of pitch cycles of said template is same with that of pitch cycles of said target segment;
a pitch cycle alignment module configured to align pitch cycles of each unit of said plurality of units except said reference unit with pitch cycles of said template by using a dynamic programming algorithm;
a pitch cycle fusion module configured to fuse said pitch cycles aligned by said pitch cycle alignment module; and
a pitch cycle concatenation module configured to concatenate said pitch cycles fused by said pitch cycle fusion module into a fused unit of said target segment.

2. The apparatus for fusing voiced phoneme units according to claim 1, wherein said pitch cycle fusion module comprises:
a pitch cycle collection module configured to extract pitch cycles aligned with each pitch cycle of said template from each unit of said plurality of units except said reference unit with respect to said each pitch cycle, wherein pitch cycles extracted by said pitch cycle collection module and said each pitch cycle are collected as a group;
a transformation module configured to Fourier-transform pitch cycles of said group to obtain magnitude spectra and phase spectra of the pitch cycles of said group;
a phase spectrum fusion module configured to fuse the phase spectra of the pitch cycles of said group;
a magnitude spectrum fusion module configured to fuse the magnitude spectra of the pitch cycles of said group; and
an inverse transformation module configured to inverse-Fourier-transform the phase spectrum fused by said phase spectrum fusion module and the magnitude spectrum fused by said magnitude spectrum fusion module to obtain said fused pitch cycle.

3. The apparatus for fusing voiced phoneme units according to claim 2, further comprising:
a primary unit selection module configured to select a primary unit from said plurality of units based on the pitch cycles aligned by said pitch cycle alignment module.

4. The apparatus for fusing voiced phoneme units according to claim 3, wherein said pitch cycle fusion module further comprises:
a power normalization module configured to normalize power of each of pitch cycles of said group to be power of a pitch cycle from said primary unit in said group.

5. The apparatus for fusing voiced phoneme units according to claim 3, wherein said magnitude spectrum fusion module comprises:
a calculation module configured to calculate a logarithm average of the magnitude spectra of the pitch cycles of said group as the fused magnitude spectrum.

6. The apparatus for fusing voiced phoneme units according to claim 3, wherein said phase spectrum fusion module is configured to use a phase spectrum of said primary unit as the fused phase spectrum.

7. The apparatus for fusing voiced phoneme units according to claim 3, wherein said pitch cycle fusion module further comprises:
a power adjustment module configured to adjust power of said fused pitch cycle to be power of a pitch cycle from said primary unit in said group.

8. The apparatus for fusing voiced phoneme units according to claim 3, wherein said primary unit selection module comprises:
a pitch cycle collection module configured to extract pitch cycles aligned with each pitch cycle of said template from each unit of said plurality of units except said reference unit with respect to said each pitch cycle, wherein pitch cycles extracted by said pitch cycle collection module and said each pitch cycle are collected as a group; and
a calculation module configured to:
calculate a similarity between each two pitch cycles in each group;
calculate the sum of similarities corresponding to said each two pitch cycles in all groups, wherein the sum is used as a similarity between two units corresponding to said each two pitch cycles in said plurality of units; and
calculate the sum of similarities of each unit of said plurality of units with other units, wherein a unit having a maximum sum of similarities with other units in said plurality of units is used as said primary unit.

9. The apparatus for fusing voiced phoneme units according to claim 1, wherein said reference unit selection module comprises a calculating module, and the reference unit is selected by:
selecting a unit from said plurality of units as a candidate unit, and creating a template based on said candidate unit and the number of pitch cycles of said target segment by using said template creation module;
aligning pitch cycles of each unit of said plurality of units except said candidate unit with pitch cycles of said template by using said pitch cycle alignment module; and
using said calculation module to:
calculate a similarity between each aligned pitch cycle pair of said template and said each unit;
calculate the sum of similarities of all aligned pitch cycle pairs of said template and said each unit, wherein the sum is used as a similarity between said template and said each unit;
calculate the sum of similarities of said candidate unit with other units of said plurality of units except said candidate unit, wherein the sum of similarities is used as a total similarity between said candidate unit and said other units; and
use said plurality of units one by one as said candidate unit and calculate a total similarity between said candidate unit and other units, wherein a unit having a maximum total similarity with other units is used as said reference unit.

10. A method for fusing voiced phoneme units in Text-To-Speech, comprising:
inputting a plurality of units for a voiced phoneme of a target segment;
dividing each unit of said plurality of units to obtain pitch cycles of said each unit;
selecting a reference unit from said plurality of units based on pitch cycle information of said each unit and the number of pitch cycles of said target segment;
creating a template based on said selected reference unit and the number of pitch cycles of said target segment, wherein the number of pitch cycles of said template is same with that of pitch cycles of said target segment;
aligning pitch cycles of each unit of said plurality of units except said reference unit with pitch cycles of said template by using a dynamic programming algorithm;
fusing said aligned pitch cycles; and
concatenating said fused pitch cycles into a fused unit of said target segment.
